(19) United States
(12) Patent Application Publication
(10) Pub. No.: US 2006/0000860 A1
(43) Pub. Date: Jan. 5, 2006

(54) Rack mount assembly for vehicle roof racks

(76) Inventor: Kenneth F. Pieciak, Grafton, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(21) Appl. No.: 10/881,084

(22) Filed: Jun. 30, 2004

(51) Int. Cl. B60R 9/00

(52) U.S. Cl. 224/319

(57) ABSTRACT

Described is a rack-mount assembly for attaching to a crossbar of a roof rack of a vehicle. The rack-mount assembly has a rack bar including a planar portion and a downward portion extending at an angle from one end of the planar portion. An attachment assembly, connected at the other end of the planar portion, is for attaching the rack bar to the crossbar of the roof rack. The planar portion of the rack bar extends above and parallel to the crossbar and the downward portion extends downward along a side of the vehicle when the attachment assembly is attached to the crossbar. One or more roof rack accessories for securing an item to the roof rack, such a clamp, a tube, a restraining bar, are mounted on a top surface of the rack bar.

### FIELD OF THE INVENTION

The invention relates generally to roof racks for vehicles and, more particularly, to rack mount assemblies for vehicle roof racks.

### BACKGROUND

Many vehicles come equipped with a roof rack for carrying luggage or various other items, such as skis, snowboards, bicycles, canoes, fishing poles, boxes, containers, and ladders. These items generally must be secured to the roof rack to prevent them from falling off while the vehicle is in motion. For this purpose, a typical roof rack has a pair of spatially separated front and rear crossbars. Each crossbar extends laterally across the top of the vehicle, and items carried on the roof rack can be tied down or clamped to one or both of these crossbars.

To assist in securing certain items to roof racks, industry has produced various accessories. Many roof rack accessories are specialized for securing a specific type of item to a roof rack. For example, special locking arms can be attached to the top of the front and rear crossbars for clamping skis and snowboards against the crossbars. However, even with the aid of accessories, securing items to a roof rack can be made difficult by a vehicle's height. Vans, minivans, and sports utility vehicles (SUVs) are examples of such vehicles with high roofs. The heights of some roofs are greater than an average person's height. Often a person will need to open a vehicle door and stand on its threshold to reach the roof rack and to secure an item thereto. Then, the person stands awkwardly while lifting the item over his or her head to place it on the roof rack. The roof height of such vehicles, therefore, can make it inconvenient and potentially unsafe to place items on such roof racks. Even for vehicles with lower roof heights, the central regions of the roof rack can still be difficult to reach.

### SUMMARY

In one aspect, the invention features a rack-mount assembly for attaching to a crossbar of a roof rack of a vehicle. The rack-mount assembly includes a rack bar having a substantially planar portion and a downward portion extending at an angle from one end of the planar portion. An attachment assembly is connected at the other end of the planar portion for attaching the rack bar to the crossbar of the roof rack. The planar portion of the rack mount extends above and parallel to the crossbar and the downward portion extends downward along a side of the vehicle when the attachment assembly is attached to the crossbar.

In another aspect, the invention features a rack-mount assembly for attaching to a crossbar of a roof rack of a vehicle. The rack-mount assembly includes a rack bar having a substantially planar portion and a downward portion extending at an angle from one end of the planar portion. A roof rack accessory, mounted to a top surface of the rack bar, is for holding a portion of an item to be carried on the roof rack. An attachment assembly, connected at the other end of the planar portion, is for attaching the rack bar to the crossbar of the roof rack. When the attachment assembly is attached to the crossbar, the planar portion of the rack bar extends above and parallel to the crossbar and the downward portion extends downward along a side of the vehicle.

In still another aspect, the invention features a roof rack for a vehicle. The roof rack includes spatially separated first and second crossbars, a first rack mount assembly attached to the first crossbar, and a second rack mount assembly attached to the second crossbar. The first rack mount assembly includes a first rack bar with a substantially planar portion and a downward portion extending at an angle from one end of the planar first portion. A first attachment assembly, connected at the other end of the planar portion, attaches the first rack bar to the first crossbar of the vehicle such that the planar portion of the first rack bar extends above and parallel to the first crossbar and the downward portion extends downwards along a portion of a side of the vehicle. A first rack accessory is mounted to a top surface of the first rack bar, for holding a portion of an item on the roof rack. The second rack mount assembly includes a second rack bar with a substantially planar portion and a downward portion extending at an angle from one end of the planar portion. A second attachment assembly, connected at the other end of the planar portion, attaching the second rack bar to the second crossbar of the vehicle such that the planar portion of the second rack bar extends above and parallel to the second crossbar and the downward portion extends downwards along a portion of the side of the vehicle. A second rack accessory is mounted to a top surface of the second rack bar, for holding a portion of an item on the roof rack.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1A is a side view of an embodiment of a rack mount of the present invention.

FIG. 1B is a top view of the rack mount of FIG. 1A.

FIG. 1C is an end view of the rack mount of FIG. 1A.

FIG. 2 is a side view of another embodiment of a rack mount of the present invention.

FIG. 3A is a view of the rack mount attached to a roof rack of a vehicle by a single attachment assembly.

FIG. 3B is a view of the rack mount attached to a roof rack of a vehicle using a plurality of attachment assemblies.

FIG. 4A is a side view of a rack-mount assembly with a plurality of clamps attached to a top surface of the rack mount of FIG. 1A.

FIG. 4B is a top view of the rack-mount assembly of FIG. 4A.

FIG. 4C is an end view of the rack-mount assembly of FIG. 4A.

FIG. 5A is a side view of a rack-mount assembly with plurality of tubes attached to the top surface of the rack mount of FIG. 1A.

FIG. 5B is a side view of the tubes attached to the top surface of the rack mount.

FIG. 5C is an end view of the rack mount with the tubes attached to the top surface.

FIG. 6 is a view of the rack mount assemblies of FIG. 4A and FIG. 5A attached to a roof rack of a vehicle.

### DETAILED DESCRIPTION

The invention features a rack-mount assembly that, in effect, extends the mounting structure of a roof rack to one side of the vehicle and lowers the mounting structure along that side for easier reach. Use of the invention is particularly advantageous for vehicles with high roofs, although the rack-mount assembly can be used on vehicles of any height. Customized embodiments of the rack-mount assembly of the invention can be made for attachment to any type of roof rack and for purposes of carrying a variety of items, for example, skis, snowboards, and fishing poles, to the roof rack. In brief overview, each rack-mount assembly includes a rack bar having a planar portion that is attached at one end to a crossbar of the roof rack. The other end of the planar portion may partially extend over one side of the vehicle when the rack bar is secured to the crossbar. A downward portion extends from this other end of the planar portion, downwardly, along a side of the vehicle. This downward portion provides a mounting structure within closer reach than the top of the roof rack. A roof rack accessory mounted on the top surface of this downward portion permits persons to mount and carry items on the roof rack along the side of the vehicle.

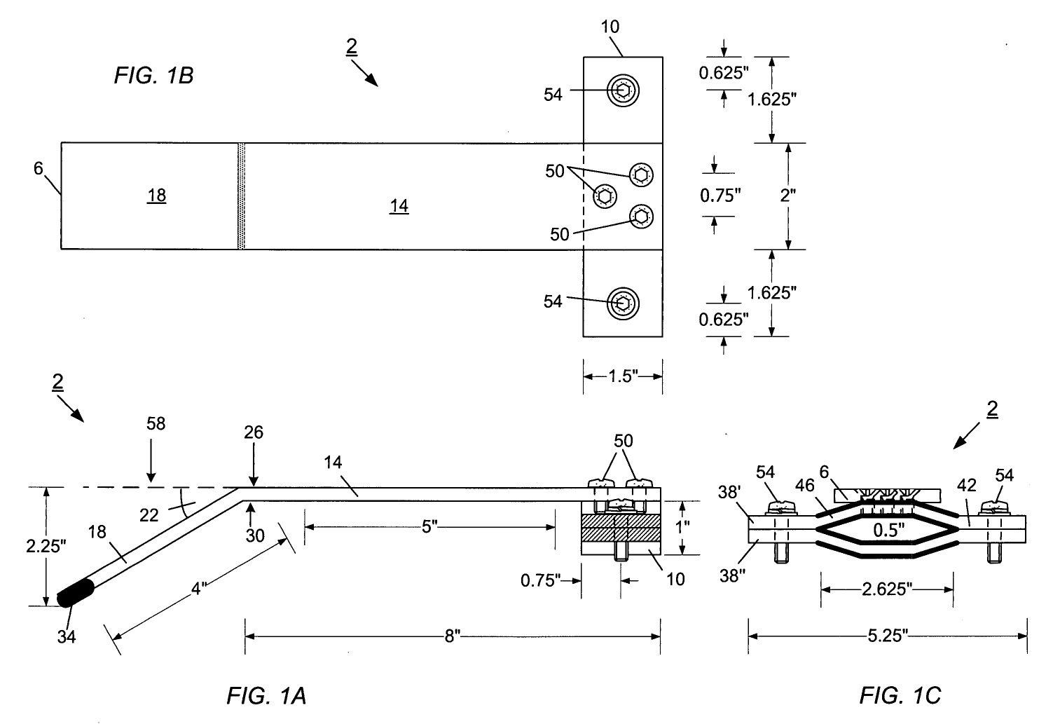

Referring to FIGS. 1A-1C, shown is an embodiment of a rack mount 2 having a rack bar 6 and an attachment assembly 10 fastened to one end of the rack bar 6. In this embodiment, the rack bar 6 extends generally perpendicularly to the attachment assembly 10. The rack bar 6 includes a substantially planar portion 14, a downward portion 18 extending from one end of the planar portion 14 at an angle 22, a top surface 26, and a bottom surface 30. In one embodiment, the rack bar 6 is a one-piece anodized aluminum bar. Other materials, such as stainless steel and plastic, can be used to construct the rack bar 6. The attachment assembly 10 is attached to the bottom surface 30 of the rack bar 6 at the other end of the planar portion 14. The particular location of the attachment assembly 10 along the rack bar 6 can vary without departing from the principles of the invention. A protective covering 34 (e.g., a rubber cap) covers a free end of the downward portion 18 to mitigate injuring anyone who may inadvertently come into contact with an installed rack mount.

The attachment assembly 10 includes top and bottom plates 38′, 38″ (generally, plate 38). Each plate 38 has a flat region 42 on each side of a shallow channel region 46. The channel region 46 of each plate 38 can be coated with an elastomeric material (e.g., rubber). Fasteners 50 secure the rack bar 6 to the attachment assembly 10. The fasteners 50 extend through aligned openings in the planar portion 14 and corresponding openings in the top plate 38′ of the attachment assembly 10. Preferably, the fasteners 50 are threaded hex screws and the corresponding openings threaded to receive them. Plates 38 can be made of metal or plastic.

To secure the attachment assembly 10 to a crossbar of a roof rack, the top plate 38′ is placed on top of and perpendicular to the crossbar, with the channel region 46 of the top plate 38′ straddling the crossbar. The lower plate 38″ is placed beneath the crossbar in alignment with the top plate 38′. Fasteners 54 passing through openings in the flat regions 42 join the plates 38 together and the joined plates 38 clamp the crossbar in between. Preferably, the fasteners 54 are threaded hex screws and the corresponding openings in the flat regions 42 are threaded to receive them. Alternatively, these openings are non-threaded through-holes, and the fasteners 54 are nut-and-bolt assemblies (e.g., wing nuts, locknuts). The length of the fasteners 54 used to clamp the plates 38 can vary based on the thickness of the crossbar. The fasteners 54 are tightened so that the rack mount 2 does not slide laterally, forward, or backward when attached to the crossbar. The elastomeric coating of the plates 38 can prevent the rack mount 2 from scratching the crossbar.

Other means can be used to attach the rack bar 6 to the crossbar without departing from the principles of the invention. For example, fasteners can be used to directly connect the rack bar 6 to the crossbar. Such an embodiment may require modifications to a standard roof rack crossbar. In contrast, an advantage of the attachment assembly 10 is that no modifications of the crossbar are necessary. Further, the attachment assembly 10 enables the rack mount 2 to be easily removed from and installed on the roof rack of one vehicle as desired.

FIGS. 1A-1C also show exemplary dimensions of one embodiment of the rack mount 2 of the invention. In this embodiment, the angle 22 is approximately 30 degrees (measured from an axis 58 defined by the top surface 26 of the planar portion 14). Also, the planar and downward portions 14, 18 are approximately ¼ inch thick, 2 inches in width, and 8 inches and 4 inches, respectively, in length. The attachment assembly 10 is approximately 1.5 inches in width and 5.25 inches in length. The degree of the angle 22, the dimensions of the planar and downward portions 14, 18, and dimensions of the attachment assembly 10 can vary according to the various types of vehicles and crossbars, which have various thicknesses and widths, to which embodiments of the rack mount 2 can be attached.

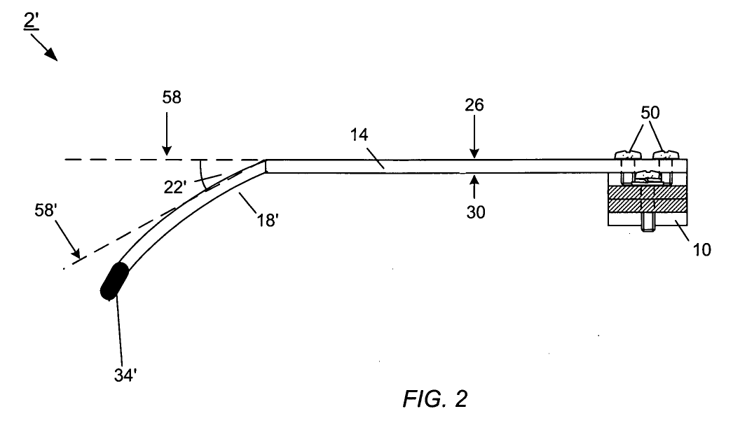

FIG. 2 shows another embodiment of a rack mount 2′. The structural features of this embodiment are, in general, similar to those of the rack mount 2 of FIGS. 1A-1C, with the exception of the downward portion 18′. Here, the downward portion 18′ of this embodiment is curved rather than straight, and the angle 22′, which, in one embodiment, is approximately 30 degrees, is measured between the axis 58 and a tangent 58′ to the downward portion 18′.

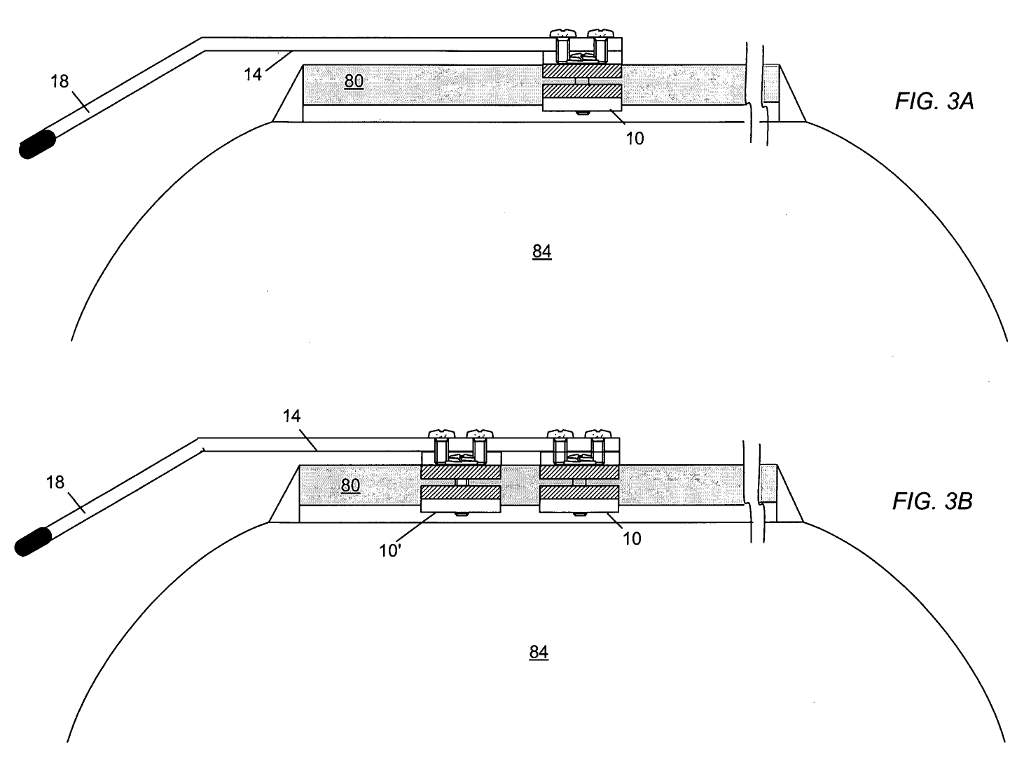

Referring to FIG. 3A, when the rack mount 2 is secured to a crossbar 80 of a roof rack of a vehicle 84, the rack bar 6 sits above the crossbar 80. The planar portion 14 of the rack bar 6 extends parallel to the crossbar 80 to one side of the vehicle 84. The attachment assembly 10 of the rack mount 2 is mounted near one side of the vehicle 84 so that the downward portion 18 can extend downwards alongside the vehicle 84. The downward portion 18 does not interfere with opening a vehicle door.

As described further below, a variety of items or objects, heavy or light, can be secured to the rack mount 2. Referring to FIG. 3B, for heavy items, i.e., those items weighing approximately 20 pounds or more, a second attachment assembly 10′ can be used to secure the rack mount 2 to the crossbar 80. In one embodiment, the second attachment assembly 10′ is spatially separated from the first attachment assembly 10 by approximately one inch.

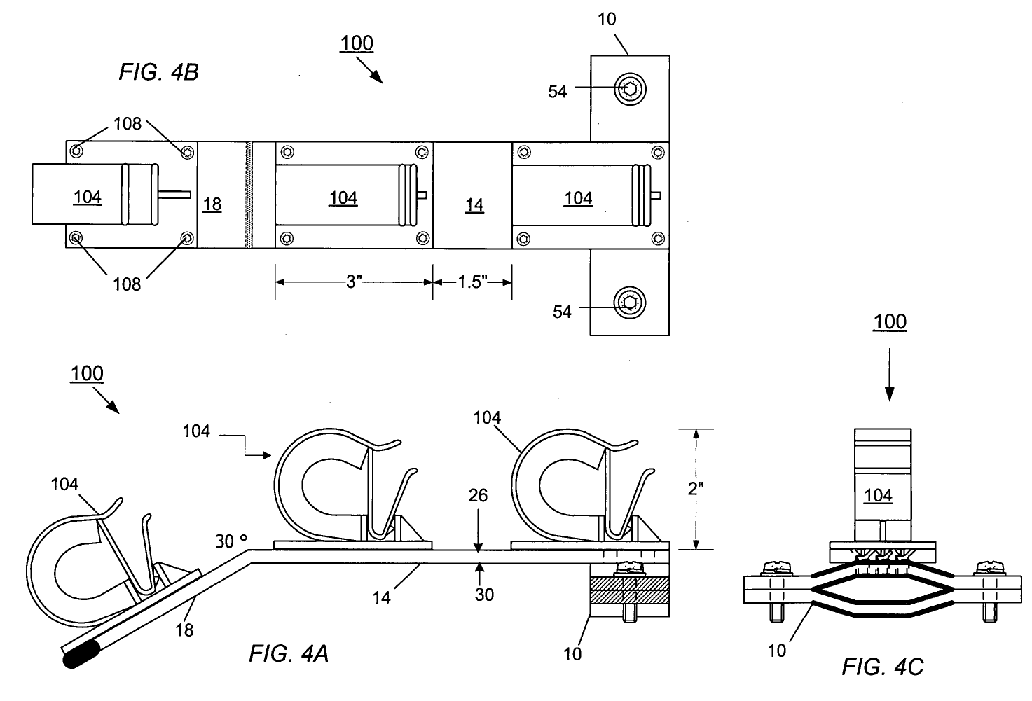

Referring to FIGS. 4A-4C, shown is an embodiment of a rack-mount assembly 100 having the rack mount 2 with a plurality of roof rack accessories 104 mounted to the top surface 26 thereof. In this example, the roof rack accessories 104 are clamps (hereafter clamps 104). Clamps 104 are one example of a type of rack accessory 104 that can be mounted on the rack mount 2 of the invention. Here, the clamps 104 are injection-molded plastic padded clamps for holding a fishing rod, such as the UY190 fishing rod holder produced by United Yachting Manufacturing of Milford, Mich. As shown, one clamp 104 is mounted on the downward portion 18 and a pair of clamps 104 is mounted on the planar portion 14. Each clamp 104 is attached to the rack mount 2 by a plurality of fasteners 108 (e.g., 8/32 hex cap screws). FIGS. 4A-4C also show exemplary dimensions of the clamps 104 and spacing between the clamps 104 on the planar portion 14. Although only one type of clamp is shown in this embodiment, other embodiments of the rack-mount assembly 100 can have different types of roof rack accessories mounted on the same rack mount 2. Also, although three clamps 104 are shown, as few as one clamp (or more than three clamps) can be used to practice the principles of the invention.

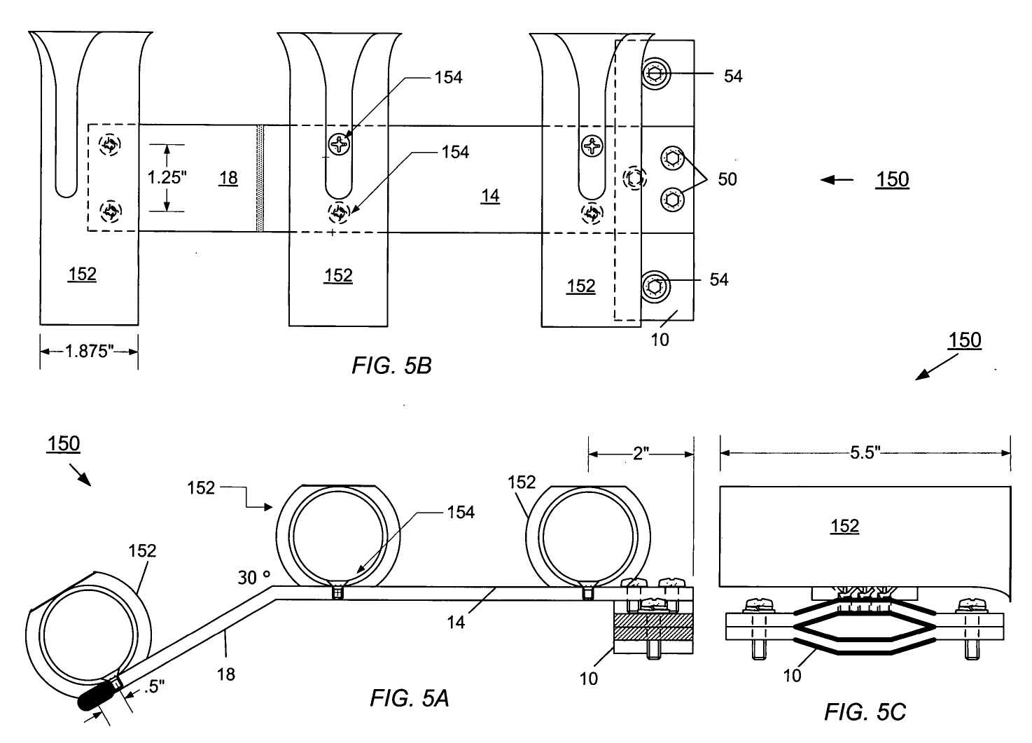

Referring to FIGS. 5A-5C, shown is another embodiment of a rack-mount assembly 150 including the rack mount 2 with a plurality of roof-rack accessories 152 mounted to the top surface 26 thereof. Here, the roof-rack accessories 152 are tubes. These tubes 152 are another example of a type of roof-rack accessory that can be mounted on the rack mount 2 of the invention. Here, the tubes 152 are standard injection-molded poly-tubes, such as the Model ETH-1 rod holders produced by Fentress Marine of Largo, Fla. As shown, one tube 152 is mounted on the downward portion 18 and a pair of tubes 152 is mounted on the planar portion 14. Each tube 152 is attached to the rack mount 2 by a plurality of fasteners 154 (e.g., flat head 10-24 screws). FIGS. 5A-5C also show exemplary dimensions of the tubes 152. Although three tubes 152 are shown, as few as one tube or more than three tubes can be used to practice the principles of the invention.

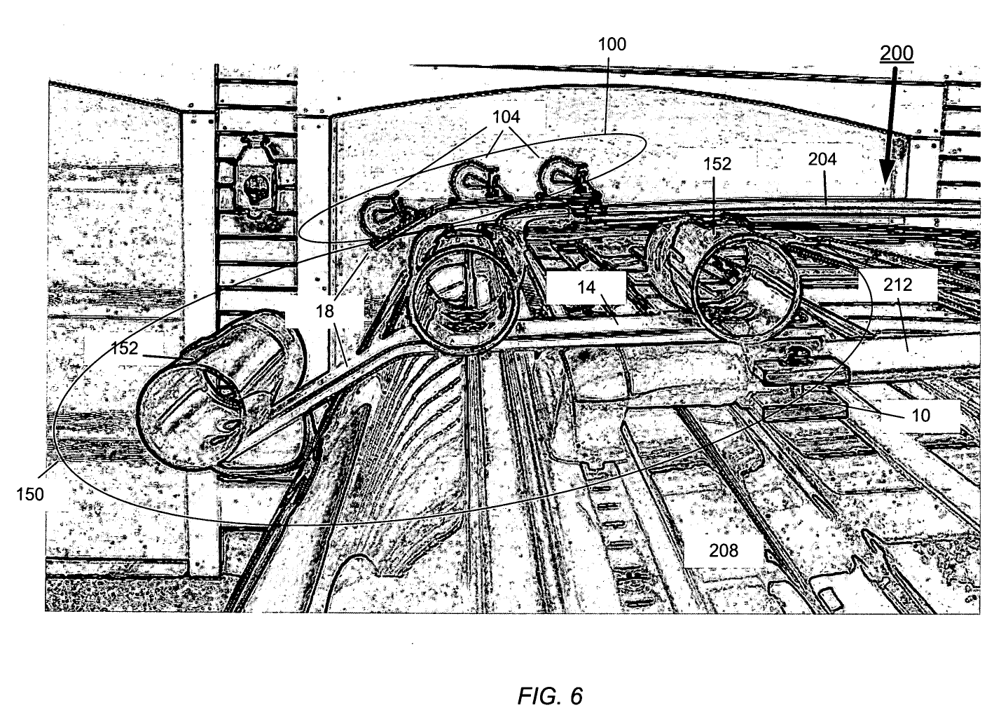

An advantage of the present invention is that different types of roof-rack accessories can be used to produce customized rack-mount assemblies. A user can then mix and match different rack-mount assemblies to customize a roof rack according to personal preferences. Further, the rack-mount assemblies can be mounted and removed on an as-needed basis without having to modify the existing roof rack on the vehicle. For example, FIG. 6 shows a customized roof rack 200 in which the rack-mount assembly 100 of FIGS. 4A-4C is attached to a front crossbar 204 of a vehicle 208 and the rack-mount assembly 150 of FIG. 5A-5C is attached to a rear crossbar 212 of the vehicle 208. The pair of rack-mount assemblies 100, 150 provides a mounting structure near one side of the vehicle. The rack-mount assemblies 100, 150 are attached to the respective crossbars 204, 212 at approximately the same location so that each clamp 104 of the rack-mount assembly 100 aligns with one of the tubes 152 of the rack-mount assembly 150. A fishing rod can be secured to the roof rack by each aligned pairing of a clamp 104 and a tube 152. The same or different rack-mount assemblies can be secured to the other ends of the crossbars 204, 212 on the other side of the vehicle 208 for holding additional items. With the rack-mount assemblies 100, 150 attached near one or both sides of the roof rack, another advantage of the present invention is that the central portion of the roof rack can still be used to carry additional items, such as a travel box.

While the invention has been shown and described with reference to specific preferred embodiments, it should be understood by those skilled in the art that various changes in form and detail may be made therein without departing from the spirit and scope of the invention as defined by the following claims.

What is claimed is:

1. A rack-mount assembly for attaching to a crossbar of a roof rack of a vehicle, the rack-mount assembly comprising:
a rack bar including a planar portion and a downward portion extending at an angle from one end of the planar portion; and
an attachment assembly, connected at the other end of the planar portion, for attaching the rack bar to the crossbar of the roof rack,
wherein the planar portion of the rack bar extends above and parallel to the crossbar and the downward portion extends downward along a side of the vehicle when the attachment assembly is attached to the crossbar.

2. The rack-mount assembly of claim 1, wherein the downward portion has a planar shape.

3. The rack-mount assembly of claim 1, further comprising at least one clamp mounted on a top surface of the rack bar.

4. The rack-mount assembly of claim 1, further comprising at least one rod holder mounted on a top surface of the rack bar.

5. The rack-mount assembly of claim 1, further comprising a protective covering at the end of the downward portion of the rack bar.

6. The rack-mount assembly of claim 1, wherein the angle is approximately 30 degrees.

7. The rack-mount assembly of claim 1, wherein the attachment assembly includes a pair of plates between which the crossbar is clamped.

8. The rack-mount assembly of claim 1, wherein the rack bar is integrally constructed of metal.

9. A rack-mount assembly for attaching to a crossbar of a roof rack of a vehicle, the rack-mount assembly comprising:
a rack bar including a planar portion and a downward portion extending at an angle from one end of the planar portion;
at least one roof rack accessory, mounted to a top surface of the rack bar, for holding a portion of an item to be carried on the roof rack; and
an attachment assembly, connected at the other end of the planar portion, for attaching the rack bar to the crossbar of the roof rack,
wherein when the attachment assembly is attached to the crossbar the planar portion of the rack bar extends above and parallel to the crossbar and the downward portion extends downward along a side of the vehicle.

10. The rack-mount assembly of claim 9, wherein the downward portion has a planar shape.

11. The rack-mount assembly of claim 9, wherein the roof rack accessory is a clamp.

12. The rack-mount assembly of claim 9, wherein the roof rack accessory is a tube.

13. The rack-mount assembly of claim 9, wherein one roof rack accessory is mounted on the top surface of the downward portion of the rack bar.

14. The rack-mount assembly of claim 9, wherein the angle is approximately 30 degrees.

15. The rack-mount assembly of claim 9 wherein the rack bar is integrally constructed of metal.

16. A roof rack for a vehicle, comprising:
spatially separated first and second crossbars;
a first rack mount assembly attached to the first crossbar, the first rack mount assembly including:
a first rack bar with a planar portion and a downward portion extending at an angle from one end of the planar portion;
a first attachment assembly, connected at the other end of the planar portion, attaching the first rack bar to the first crossbar such that the planar portion of the rack bar extends above and parallel to the first crossbar and the downward portion extends downwards along a portion of a side of the vehicle; and
a first rack accessory mounted to a top surface of the first rack bar, for holding a portion of an item on the roof rack; and
a second rack mount assembly attached to the second crossbar, the second rack mount assembly including:
a second rack bar with a planar portion and a downward portion extending at an angle from one end of the planar portion;
a second attachment assembly, connected at the other end of the planar portion, attaching the second rack bar to the second crossbar such that the planar portion of the rack bar extends above and parallel to the second crossbar and the downward portion extends downwards along a portion of the side of the vehicle; and
a second rack accessory mounted to a top surface of the second rack bar, for holding a portion of an item on the roof rack.

17. The roof rack of claim 14, wherein the first roof rack accessory is a clamp and the second roof rack accessory is a rod holder.

18. The roof rack of claim 14, wherein the first rack accessory is mounted on the top surface of the downward portion of the first rack bar and the second rack accessory is mounted on the top surface of the downward portion of the second rack bar.

19. The roof rack of claim 14, wherein the angle of the downward portion for each rack bar is approximately 30 degrees.

20. The roof rack of claim 14, wherein each rack bar is integrally constructed of metal.
